(19) United States
(12) Patent Application Publication
(10) Pub. No.: US 2013/0007709 A1
(43) Pub. Date: Jan. 3, 2013

(54) SOFTWARE CONFIGURATION MANAGEMENT

(75) Inventors: SI BIN FAN, BEIJING (CN); JINFAN SHAW, SANJOSE, CA (US); HONG LIANG HAN, BEIJING (CN); LIAN PING ZHANG, BEIJING (CN)

(73) Assignee: INTERNATIONAL BUSINESS MACHINES CORPORATION, ARMONK, NY (US)

(21) Appl. No.: 13/468,128

(22) Filed: May 10, 2012

(30) Foreign Application Priority Data
Jun. 30, 2011 (CN) 201110180713.7

(51) Int. Cl. G06F 9/44

(52) U.S. Cl. 717/121

(57) ABSTRACT

Dependency information corresponding to an artifact can be generated. In response to the generation of the dependency information, information version information is generated for the dependency corresponding to that of the artifact. In response to the update of the artifact, the dependency information corresponding to the artifact is updated. In response to the update of the dependency information, new version information is assigned to the updated dependency information, such that the new version information corresponds to the version information of the updated artifact.

### CROSS REFERENCE TO RELATED APPLICATIONS

This application claims priority of the Chinese Application No. 201110180713.7 entitled “APPARATUS AND METHOD FOR SOFTWARE CONFIGURATION MANAGEMENT”, filed on Jun. 30, 2011.

### BACKGROUND

The present invention relates to a method, system, and program for software configuration management.

In the field of software engineering, during the development of a software project, developers would usually modify and change the codes for many times until they get the final version of the software. In addition, for a big software project, the relatively independent functional features in the software project would generally be assigned to many members of a project team for parallel development, that is, each developer develops and modifies the functional feature that he takes charge of, and then the project manager combines the functional features developed by the developers, thereby completing a software project. During software development as described above, as many developers change the various functional features of the software for many times, the change would possibly cause confusion among the software developers in the project team; therefore, a professional tool is desired to manage the software development.

Software Configuration Management (SCM) is a technique of identifying, organizing and controlling software changes during the software development. In particular, SCM includes version control, change control, status report, etc. as the main functions.

Version control is the key function of SCM. In this function, all the elements in the configuration library would be automatically assigned with a version label, whose nomenclature is guaranteed to be unique. Once input into the configuration library, any artifact produced during the software development (including computer program source files, program description documents and other data) will automatically receive a unique version identifier. Any changes to the artifact are indexed and managed according to the version identifiers.

### BRIEF SUMMARY

In one embodiment of the disclosure, dependency information corresponding to an artifact can be generated. In response to the generation of the dependency information, information version information is generated for the dependency corresponding to that of the artifact. In response to the update of the artifact, the dependency information corresponding to the artifact is updated. In response to the update of the dependency information, new version information is assigned to the updated dependency information, such that the new version information corresponds to the version information of the updated artifact.

In one embodiment, the disclosure provides an apparatus for software configuration management through a system that includes: an information-generating unit, configured to generate dependency information corresponding to an artifact; a version-generating unit, configured to, in response to the generation of the dependency information, generate for the dependency information version information corresponding to that of the artifact; an information-updating unit, configured to, in response to the update of the artifact, update the dependency information corresponding to the artifact; and a version-updating unit, configured to, in response to the update of the dependency information, assign new version information to the updated dependency information, such that the new version information corresponds to the version information of the updated artifact.

### BRIEF DESCRIPTION OF THE SEVERAL VIEWS OF THE DRAWINGS

FIG. 1A shows the architecture of the centralized IA repository in the prior art.

FIG. 1B shows the architecture of the private IA repository in the prior art;

FIG. 2 shows a block diagram of the apparatus for software configuration management according to an embodiment of the invention.

FIG. 3 shows an example of generating dependency information according to an embodiment of the invention.

FIG. 4 shows the substructure of the information-updating unit according to an embodiment of the invention.

FIG. 5 shows a schematic diagram of a nested query according to an embodiment of the invention.

FIG. 6 shows a flow chart of the method for software configuration management according to an embodiment of the invention.

FIG. 7 shows a block diagram of an exemplary computing system 100 adapted to implement the embodiments of the invention.

### DETAILED DESCRIPTION

After identifying, and performing version management on, the artifacts, another important task for SCM is how to ensure they are under control during the development, and they can restore conveniently to any history state in any case. Thus, a change control is desired. The core of the change control can be understood as the establishment and advance of baselines. According to the definition by IEEE, a “baseline” refers to a formally evaluated and approved standard or product; therefore, it serves as basis for further development, and it must be changed through a formal change procedure. Thus, for various baseline-controlled items in the configuration library, the access permissions should be set according to the location and status of the corresponding baseline. Generally speaking, all versions before the baseline are in lock state. If it is necessary to change them, the change will be controlled by a procedure of examining the access permissions, testing new baselines, examining artifact changes, etc.

In addition, SCM further includes the function of status report, that is, to report the progress of software development according to the records in the artifact operation database. Especially in the case of changes, SCM should report the changes to related personnel.

By the functions described above, SCM traces and manages the procedure of software development in the form of versions, thereby reducing errors and enhancing efficiencies. Commonly used SCM tools include ClearCase, CVS, Endevor, RTCz, etc.

On the other hand, during the process of software development, the software artifacts produced by developers are generally interrelated closely, for example, in the relationship of calling and being called. When a developer revises a source code to change an artifact, other artifacts relating to the changed artifact must also be revised accordingly so as to keep the consistency of the software. To this end, Impact Analysis (IA) for software artifacts is needed to obtain the dependency information among the artifacts, and recognize the potential consequences of the code revision. A tool for performing the impact analysis is referred to as an IA tool. Generally, during the software development, developers need to first perform the impact analysis before changing the artifact.

As described above, SCM tool is to manage changes of the software and IA tool is to manage consequences of changes. These two have close relationship. Many SCM products provides IA feature. In general, IA feature is provided in two approaches: Centralized IA repository and Private IA repository.

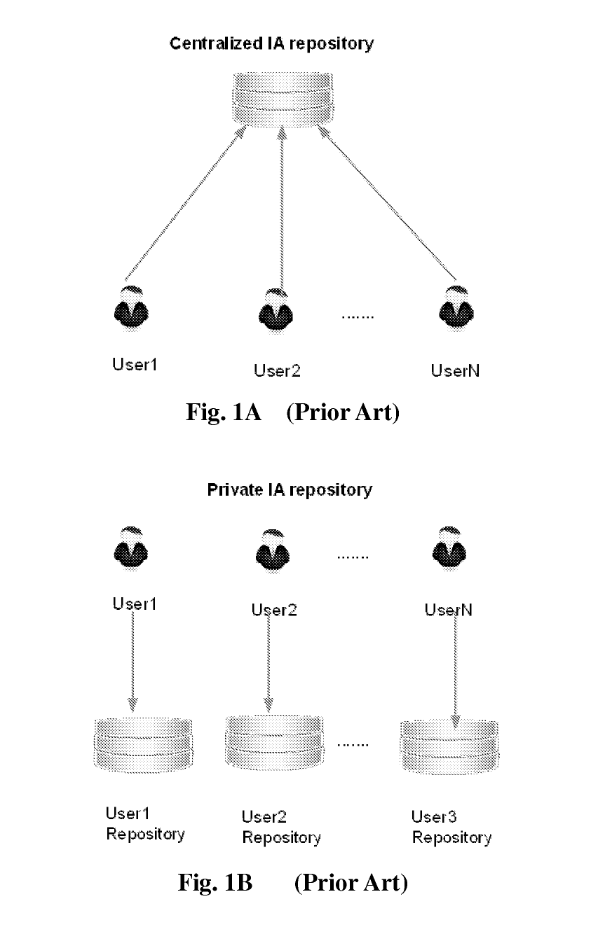

FIG. 1A shows the architecture of the centralized IA repository in the prior art. For the centralized IA repository, the IA dependency data are built based on baseline of certain stream/branch, and updated periodically. All developers and other users, such as users from 1 to n in FIG. 1, use the centralized IA repository to query dependency information. One disadvantage of this approach is that the IA data is not updated or accurate for all users. For developers, they may make changes in their own stream/branch, but the changes are not reflected in the centralized IA repository. In addition, since the centralized IA repository is built based on certain baseline, if users are working on other baselines, the IA data are not accurate.

FIG. 1B shows the architecture of the private IA repository in the prior art. As shown in the figure, for private IA repository, all users build their own IA repository for storing dependency data. This approach has two disadvantages: first, building IA data is slow especially if there are many source files; second, all users building their own IA dependency data means a lot of duplicate effort.

In addition, the existing IA tool also has the problem of the incapability in restoring IA data. For example, when a software product is updated from version 1 to version 2, with the advancement of the baseline, the IA tool also updates IA data to provide the dependency information among the artifacts in the current version 2. If now the manager finds that version 2 has a problem and wants to restore to version 1, the software product can be conveniently restored to the desired version since the SCM tool manages the artifacts based on versions. However, the IA tool cannot save the previous data after updating data, and thus cannot restore to the dependency information of a previous version; it has to analyze the artifacts of version 1 once again to obtain IA data.

Therefore, as described above, the existing IA tool has many disadvantages to be improved, which was identified by the inventors during the course of this disclosure.

In embodiments of the disclosure, an IA feature is introduced to and integrated with the software configuration management (SCM) tool, such that the IA data can be stored and managed in the form of versions like the artifacts in the process of software development. The artifacts include all the products produced in the process of software development, such as, source files, models, description documents, etc. Accordingly, the solutions according to the embodiments of the invention may be applied to any artifact as long as the artifact has relationship with other artifacts, and changing the artifact may possibly cause changes of other artifacts.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 2 shows a block diagram of the apparatus for software configuration management according to an embodiment of the invention. As shown in the figure, SCM apparatus 20 comprises: an information-generating unit 22, a version-generating unit 24, an information-updating unit 26, and a version-updating unit 28. The information-generating unit may be configured to generate dependency information corresponding to the artifact. The version-generating unit 24 may be configured to, in response to the generation of the dependency information, generate for the dependency information version information corresponding to that of the artifact. The information-updating unit 26 may be configured to, in response to the update of the artifact, update the dependency information corresponding to the artifact. The version-updating unit 28 may be configured to, in response to the update of the dependency information, assign new version information to the updated dependency information, such that the new version information corresponds to the version information of the updated artifact.

In particular, the information-generating unit 22 is used to generate the initial dependency information corresponding to an initial artifact. During the typical process of developing software with an SCM tool, developers submit an initial artifact to a manager, and after examination the manager stores it in a particular library of the SCM apparatus, that is, creating an initial artifact in the library. In one example, in response to the creation of the initial artifact, the information-generating unit 22 automatically analyzes the created artifact and generates the corresponding dependency information. Or alternatively, in another example, the information-generating unit 22 is triggered by the manager or users, and begins to analyze a particular artifact, thereby generating the corresponding dependency information.

The information-generating unit 22 may generate the dependency information in many ways. In one embodiment, the information-generating unit 22 calls the IA data generation engine in the prior IA tool, thereby generating dependency information. In another embodiment, the information-generating unit 22 comprises a special generating module, which generates the dependency information relating to a particular artifact. The dependency information may comprise contents of many aspects, including but not limiting to, one or more of the following: which files the artifact cites; which variables the artifact cites; which functions the artifact calls; which artifacts cite the artifact; which artifacts cite the variables in the artifact; and the like.

The detailed modes of generating dependency information will be described below in conjunction with examples of source files. In particular, in one example, the information-generating unit 22 generates dependency information by static scanning. In the mode of static scanning, the information-generating unit 22 obtains the dependency information between the source file and other artifacts by scanning the source code in the static source file and analyzing the source code.

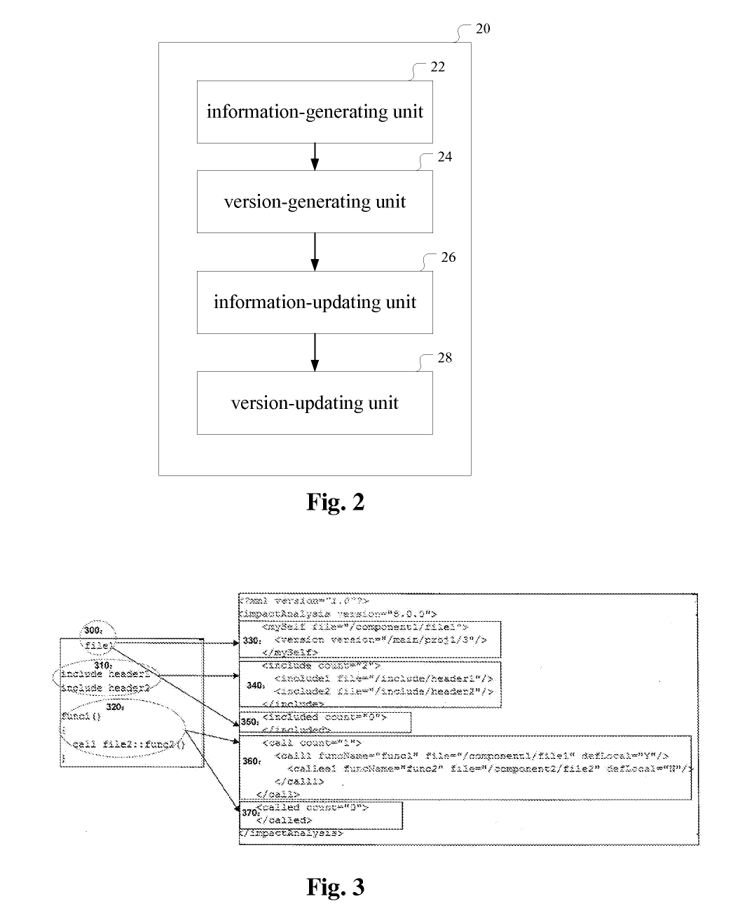

FIG. 3 shows an example of generating dependency information according to an embodiment of the invention. As shown in FIG. 3, the source file names itself as file1 in section 300, cites two files—header1 and header2—in section 310, and defines a function—func1—in section 320. For such a source file, the information-generating unit 22 may obtain dependency data among files by scanning the source codes in various sections, and recognizing and analyzing the identifying codes. For example, by recognizing and analyzing section 310, it may obtain the dependency information as shown in section 340, including the number of files cited by the source file (count=“2”), the paths of the cited files (file=“/include/header1”/, file=“/include/header2”/), and the like; by recognizing and analyzing section 320, it may obtain the dependency information between the defined function func1 and other files, for example, as shown in section 360, the number of functions called by func1 is one (1) (count=“1”), the name of the called function is func2, the source of the called function is file2, and as shown in section 370, the number of times that func1 is called is zero(0) (count=“0”).

In another example, the information-generating unit 22 generates dependency information by program compilation. Those skilled in the art can understand that, during the process of program compilation, the compiler scans, analyzes, compiles and converts the program codes. By adding special instructions when compiling programs, the compiler may extract data relating to the citation and calling of files and functions. The information-generating unit 22 can capture said data generated by the compiler and save them as the dependency information.

In another example, the information-generating unit 22 generates dependency information by dynamic scanning. In particular, the information-generating unit 22 may dynamically capture the citation of other files by the program from the runtime environment when running the program, and thereby generate dependency information.

The detailed examples described above illustrate the modes in which the information-generating unit 22 generates dependency information, but it can be understood that the examples are not limiting. Those skilled in the art may generate dependency information by appropriate manners depending on the type of the artifact and the requirement of the analysis in practice.

For the generated dependency information, the information-generating unit 22 may store it in many ways. In the example shown in FIG. 3, the information-generating unit 22 obtains the dependency information in the XML format. In another particular example, the information-generating unit 22 may store the dependency information in the form of database tables, for example, each row of the table is used to store a piece of citing/being cited or calling/being called relationship. In another example, the information-generating unit 22 may store the dependency information in other formats, such as in text format. In one embodiment, the information-generating unit 22 stores the dependency information as a separate file, such as the above mentioned XML file, database table file, text file, etc. In another embodiment, the information-generating unit 22 does not store the generated dependency information separately, but adds it to the initial artifact file as auxiliary information or description information. Thus, users may review the dependency information by checking properties of the artifact file, and the like.

As described above, the information-generating unit 22 generates the initial dependency information based on the analysis to the initial artifact file. After that, the version-generating unit 24 adds version information to thus generated initial dependency information.

The SCM apparatus can manages the artifacts stored therein in the form of versions. Therefore, the SCM apparatus 20, like general SCM tools, comprises a version management module, which generates version information for artifacts by using particular algorithms. Thus, when an initial artifact file is created in the storage library of the SCM apparatus 20, the version management module establishes the initial version information for the initially created artifact file, such as the version number v0. Once the information-generating unit 22 generates the dependency information relating to the artifact file of version v0, the version-generating unit 24 according to an embodiment of the invention will also create version information for the dependency information, such that the version information corresponds to the artifact file version number v0.

In one embodiment, the version-generating unit 24 is formed by reusing the version management module mentioned above. That is, we may revise the prior version management module, such that the version management module regards the initial dependency information generated by the information-generating unit 22 as a newly created artifact, and therefore establishes version information for the initial dependency information according to the existing algorithms of the module similarly, that is, according to the creation manner of version information for ordinary artifacts. In this case, the revised version management module may serve as the version-generating unit 24.

In another embodiment, the version-generating unit 24 generates version information independently from the version management module. In particular, the version-generating unit 24 may generate the initial version information for the initial dependency information by using a different mode than that of the version management module. In one particular example, the version-generating unit 24 directly refers to the version number v0 of the artifact file, which the dependency information is based on, and assigns the same version number to the corresponding dependency information. In another example, the version-generating unit 24 adds a special suffix to the artifact file version number v0, such as v0-0, thereby generating the version information for the dependency information corresponding to the artifact file. Or alternatively, in one example, the version-generating unit 24 generates version information by using a different algorithm than that of the artifact file. In addition, those skilled in the art can expect other modes of generating version information after reading the specification.

No matter reusing the existing module or taking a new unit, or no matter what modes and algorithms to be used, the generated version information should satisfy at least the following conditions: firstly, each piece of dependency information should have its unique version information; secondly, the version information of the dependency information and the version information of the corresponding artifact file are associated and corresponded, and the rules for association and correspondence may be determined in advance. That is, if the version information of the dependency information and the version information of the artifact file are identical (for example, due to the reuse of the existing module), the relation between them can be easily determined; if they are different, the requirement is that, from the version information of the artifact file, the version information of the corresponding dependency information can be determined according to a predetermined relating rule.

Thus, by using the information-generating unit 22 and the version-generating unit 24 as described above, it can create initial dependency information for the initial artifact file in the SCM apparatus 20, and assign initial version information for the initial dependency information. However, the software artifact will not stay unchanged in its initial version, but be revised and updated continually by developers and managers, which is just the important task for SCM management. Then, in the case of introducing dependency information, when a software artifact is changed and updated, the SCM apparatus 20 should manage the dependency information and the change thereof similarly.

Thus, the SCM apparatus 20 comprises an information-updating unit 26, configured to, in response to the update of the artifact, update the dependency information corresponding to the artifact. In one embodiment, the SCM apparatus 20 provides users with an interactive interface, such as an option, and when a user finishes updating a software artifact, he may confirm or save the update by clicking the option. By detecting the operation on the interactive interface, the information-updating unit 26 can obtain the update of the artifact, and thus update the corresponding dependency information. In another embodiment, once the information-updating unit 26 detects the change of the artifact version information, it will update the dependency information corresponding to the artifact. It can be understood that the information-updating unit 26 may detect or obtain the update of artifacts in other ways, for example, by scanning the artifacts regularly, receiving reports of changes, and the like. Once the artifact stored in the SCM apparatus 20 is updated, the information-updating unit 26 is triggered to update the related dependency information.

The information-updating unit 26 may update dependency information in many ways. In one embodiment, the information-updating unit 26 reanalyzes the updated artifact file, and regenerates dependency information as the updated dependency information. The analysis to the updated artifact file may be performed by any means, for example, by static scanning or program compilation, which means can be the same as or different from that employed by the information-generating unit 22. In another embodiment, the information-updating unit 26 obtains a part of the artifact file which is different before and after the update, and revises the initial dependency information based on the differential part, thereby obtaining the updated dependency information. For the updated dependency information, the information-updating unit 26 may store the whole contents as a separate file, or only store the differential part than the initial dependency information.

Once the information-updating unit 26 generates updated dependency information, the version-updating unit 28 will update the version information of the dependency information, such that the updated version information corresponds to the version information of the updated artifact. In particular, the version-updating unit 28 may employ a similar way to the version-generating unit 24 to generate new version information for the updated dependency information. As described above, before the update, the version information of the dependency information and the version information of the related artifact file are associated and corresponded according to a particular rule; as long as the version-updating unit 28 updates version information according to the same rule, it can be ensured that the updated version information corresponds to the version information of the updated artifact file, that is, keeping corresponding relationship between the two pieces of version information.

In one embodiment, the information-updating unit 26 and the version-updating unit 28 realize the update of dependency information and the version information thereof by reusing the existing check-out and check-in mechanism in the prior SCM apparatus. In particular, as known by those skilled in the art, the software artifact in the SCM apparatus 20 is generally updated through a check-out and check-in procedure. When a user wants to revise a software artifact, he should first go through the examination on his access permission by the SCM apparatus 20, and then check-out the artifact from the storage library. After the check-out, the SCM apparatus 20 revises the status label of the artifact, for example, labeling it as updating. After the check-out, the user may revise the artifact. Then, after revision, the user should submit the updated artifact to the storage library of the SCM apparatus 20 through a check-in procedure. Once the updated artifact is checked-in to the storage library, the SCM apparatus 20 will revise the status label of the artifact, for example, labeling it as read-only. And in response to the check-in action, the version management module in the SCM apparatus 20 will believe that the artifact has been updated, and therefore update the version information of the artifact, for example, upgrading the version number from the initial v0 to v1.

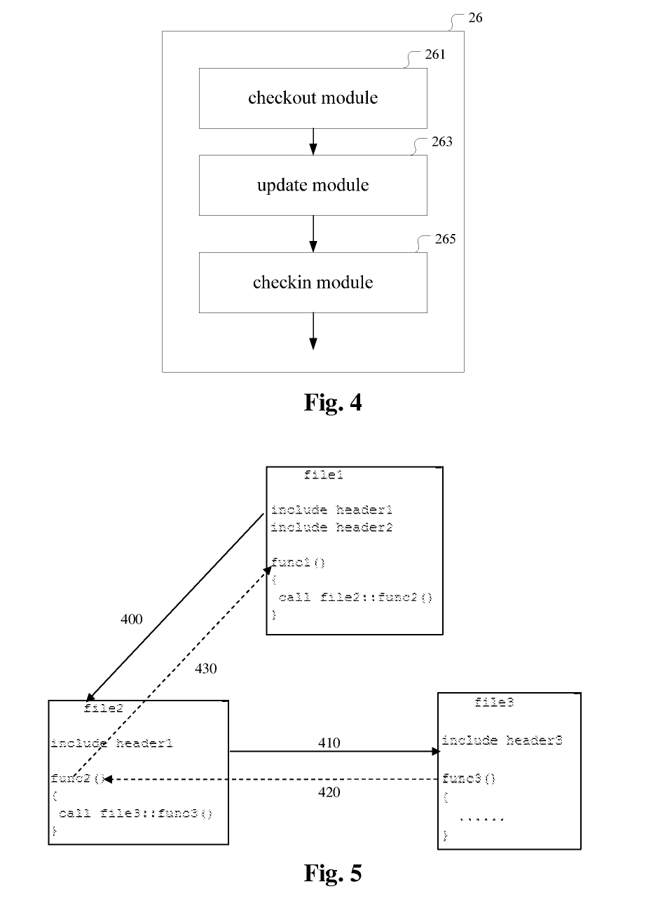

Accordingly, in one embodiment, the information-updating unit 26 comprises sub-modules relating to the check-out and check-in. FIG. 4 shows the substructure of the information-updating unit according to an embodiment of the invention. As shown in the figure, the information-updating unit 26 further comprises a check-out module 261, an update module 263 and a check-in module 265. The check-out module 261 is configured to, in response to the check-out of the artifact, check-out the dependency information corresponding to the artifact; the update module 263 is configured to, based on the updated artifact, update the dependency information; and the check-in module 265 is configured to, in response to the check-in of the updated artifact, check-in the updated dependency information. In particular, the check-out module 261 allows the dependency information to be checked-out together with the corresponding artifact, such that the status of the dependency information is also labeled as updating by the SCM apparatus 20. Subsequently, in response to the update of the artifact (for example, by receiving user's operation on a particular interactive interface), the update module 263 updates the dependency information in a way as described above. Then, once the user checks-in the updated artifact to the SCM apparatus 20, the check-in module 265 would simultaneously check-in the updated dependency information corresponding to the updated artifact to the SCM apparatus 20. Alternatively, in another embodiment, the update module 263 and the check-in module 265 may be combined as an update-check-in module, such that the check-in of the updated artifact is also considered as the triggering condition for updating the dependency information. That is, once detecting the check-in of the updated artifact, the update-check-in module would, based on the updated artifact, update the corresponding dependency information, and check-in the updated dependency information to the SCM apparatus 20.

On the basis that the information-updating unit 26 introduces a function of checking-out and checking-in dependency information, the version-updating unit 28 can completely reuse the existing version management module in the SCM apparatus 20. With the check-in of dependency information, the version management module updates the version information of the file newly checked-in in response to the check-in action, like the way of treating other software artifacts. That is, the version management module accordingly updates the version information of the dependency information according to the updating rule for the version information of ordinary artifacts. Thus, the existing version management module serves as the version-updating unit 28, automatically assigning new version information to the updated dependency information.

By using the SCM apparatus 20 described in the above embodiments, the dependency information for IA analysis is also stored and managed in the form of versions. Whenever an artifact in the SCM storage library is changed, the related dependency information is also updated, and the version of the dependency information is changed with it so as to keep correspondence with the version information of the artifact. This allows developers and managers to obtain the dependency information of any version. In addition, in a parallel cooperation development environment, the apparatus 20 realizes the reuse of dependency information well. In particular, in said development environment, each developer creates his own private branch based on the backbone of the project. After creating the branch, all the artifacts and the corresponding dependency information under the branch can be obtained by inheriting from the backbone. Thus, the dependency information of the backbone can be shared and reused among the developers. And when the developers update the software artifacts, the corresponding dependency information would also be updated. When a developer submits a revised artifact from his private branch to the backbone, the dependency information is also incorporated and stored in a corresponding library, such that updated and accurate dependency information is maintained in the SCM apparatus, without changing the existing architecture of the parallel development system.

In order to allow the SCM apparatus 20 to interact with users better, in one embodiment, the SCM apparatus 20 further comprises a query unit, which is used to query about dependency information of artifacts in response to the request of users. In particular, the query unit may provide an interface for receiving the query request from users and returning the query result to users.

In one embodiment, the request from users may be a direct query request, for example, a request for querying about the dependency information corresponding to an artifact of a particular version, or a request for directly querying about the dependency information of a particular version. In this case, the query unit searches in the storage library based on the name and/or version information of the artifact, thereby obtains the requested dependency information, and provides it to users via the interface.

In one embodiment, the request from users may be a nested query request, for example, a request for querying about all artifacts that are influenced by a particular artifact, directly or indirectly. In this case, the query unit first searches and analyzes the dependency information of the requested particular artifact, and acquires from it which artifacts cite or call the particular artifact and the variables and functions contained therein. For each artifact (referred to as second artifact hereinafter) that is determined as citing or calling the particular artifact, the query unit then searches and analyzes the dependency information of the second artifact, and acquires the artifacts that are directly influenced by the second artifact; this process is conducted until the searched artifact is not cited by any other artifact. FIG. 5 shows a schematic diagram of a nested query according to an embodiment of the invention. As shown in FIG. 5, file 1 defines a function func1, and func1 calls a function func2 in file 2; it can be known from analyzing file 2 that the function func2 in file 2 calls a function func3 in file 3 in turn. The solid arrows 400, 410 in FIG. 5 show the above calling relationship. Such calling relationship is recorded in the dependency information of the respective files 1-3. If a user wants to know which files will be influenced when changing file 3, he should backtrack along the direction of the dotted arrows, opposite of the direction of the solid arrows, and thereby determine the files influenced by file 3. In particular, by searching and analyzing the dependency information of file 3, the query unit can know that func3 in file 3 is called by file 2, and thus the query unit searches and analyzes the dependency information of file 2. When the querying process comes to file 1, it is found that file 1 is not called by any other file, and thus the query unit stops querying and searching, and returns the result of above analysis to users. In above examples, the querying process does not stop until it comes to the “root” artifact, that is, an artifact which is not cited by any other artifact. However, in one embodiment, the query unit may receive the setting on querying steps of the nested query from users, allowing the querying process to stop at a particular citation level.

By using the SCM apparatus 20 described above, the dependency information is stored and managed in the form of versions, and can be conveniently searched and queried. Therefore, developers and managers can conveniently obtain updated, accurate and recoverable dependency information.

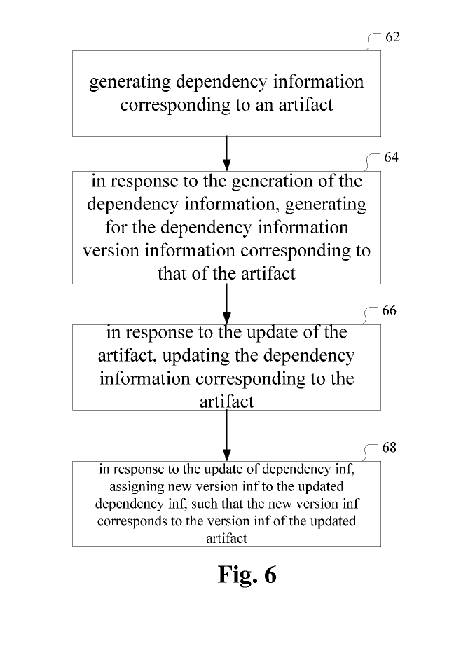

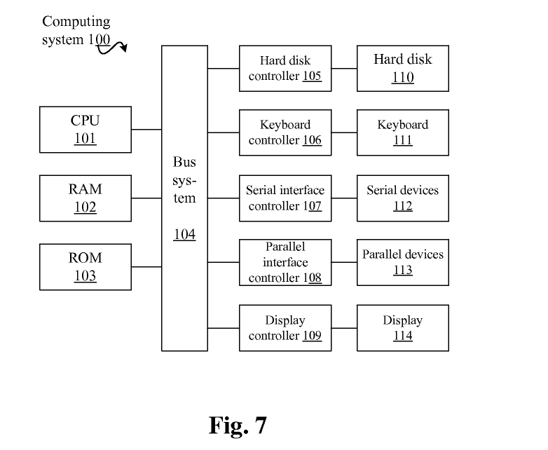

Based on the same inventive concept, the present invention further provides a method for software configuration management. FIG. 6 shows a flow chart of the method for software configuration management according to an embodiment of the invention. As shown in the figure, the method for SCM comprises: step 62, generating dependency information corresponding to an artifact; step 64, in response to the generation of the dependency information, generating for the dependency information version information corresponding to the artifact; step 66, in response to the update of the artifact, updating the dependency information corresponding to the artifact; and step 68, in response to the update of the dependency information, assign new version information to the updated dependency information, such that the new version information corresponds to the version information of the updated artifact.

In one embodiment, step 66 further comprises a check-out step, an update step and a check-in step. In the check-out step, in response to the check-out of the artifact, it checks-out the dependency information corresponding to the artifact; in the update step, based on the updated artifact, it updates the dependency information; and in the check-in step, in response to the check-in of the updated artifact, it checks-in the updated dependency information. Alternatively, in another embodiment, the update step and the check-in step may be combined as an update-check-in step. In the update-check-in step, once detecting the check-in of the updated artifact, it would, based on the updated artifact, update the related dependency information, and check-in the updated dependency information.

In one embodiment, the method for SCM further comprises a query step for querying about dependency information of artifacts in response to the request of users. The request from users may be a direct query request or a nested query request. In the case of a nested query request, the query step comprises: searching and analyzing the dependency information of the requested particular artifact, and acquiring from it which artifacts cite or call the particular artifact; for each artifact thus acquired, searching and analyzing the related dependency information until the obtained artifact is not cited by any other artifact.

The specific implementing modes of the method for SCM are not detailed herein as reference can be made to the description of the SCM apparatus 20. By using the above method, in the process of software development, the artifact-related dependency information can be stored and managed in the form of versions, helping developers and managers to obtain and analyze it.

The SCM apparatus 20 and the method for SCM as described above may be realized by using a computing system. FIG. 7 shows a block diagram of an illustrative computing system 100 adapted to implement embodiments of the invention. As shown, the computer system 100 may comprise: a CPU (Central Processing Unit) 101, a RAM (Random Access Memory) 102, a ROM (Read-Only Memory) 103, a system bus 104, a hard disk controller 105, a keyboard controller 106, a serial interface controller 107, a parallel interface controller 108, a display controller 109, a hard disk 110, a keyboard 111, a serial external device 112, a parallel external device 113 and a display 114. Among these devices, the system bus 104 couples to the CPU 101, the RAM 102, the ROM 103, the hard disk controller 105, the keyboard controller 106, the serial controller 107, the parallel controller 108 and the display controller 109. The hard disk is coupled to the hard disk controller 105, the keyboard 111 is coupled to the keyboard controller 106, the serial external device 112 is coupled to the serial interface controller 107, the parallel external device 113 is coupled to the parallel interface controller 108, and the display 114 is coupled to the display controller 109. It is appreciated that, the structural block diagram shown in FIG. 10 is merely for purpose of illustration, rather than being a limitation to the scope of the invention. In some circumstances, certain devices may be added or removed based on actual condition.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. An apparatus comprising:
an information-generating unit configured to generate dependency information corresponding to an artifact;
a version-generating unit configured to, in response to the generation of the dependency information, generate for the dependency information version information corresponding to that of the artifact;
an information-updating unit configured to, in response to the update of the artifact, update the dependency information corresponding to the artifact; and
a version-updating unit configured to, in response to the update of the dependency information, assign new version information to the updated dependency information, such that the new version information corresponds to the version information of the updated artifact.

2. The apparatus according to claim 1, wherein the information-generating unit is configured to generate dependency information by the way selected from one or more of the following:
static scanning;
program compilation; and
dynamic scanning.

3. The apparatus according to claim 1, wherein the version-generating unit is configured to regard the generated dependency information as an artifact, and generate version information for the dependency information according to the creation manner of the artifact version information.

4. The apparatus according to claim 1, wherein the version-generating unit is configured to generate version information for the dependency information in a different way than that of the creation of the artifact version information.

5. The apparatus according to claim 1, wherein the information-updating unit is configured to detect the update of the artifact by the way selected from one or more of the following items:
detecting the operation on interactive interfaces;
detecting the change of the version information of the artifact;
scanning the artifact regularly; and
receiving reports of changes.

6. The apparatus according to claim 1, wherein the information-updating unit is configured to reanalyze the updated artifact, and regenerate dependency information as the updated dependency information.

7. The apparatus according to claim 1, wherein the information-updating unit is configured to obtain a part of the artifact which is different before and after the update, and revise the dependency information based on the differential part, thereby obtaining the updated dependency information.

8. The apparatus according to claim 1, wherein the information-updating unit comprises:
a check-out module configured to, in response to the check-out of the artifact, check-out the dependency information corresponding to the artifact;
an update module, configured to, based on the updated artifact, update the dependency information; and
a check-in module configured to, in response to the check-in of the updated artifact, check-in the updated dependency information.

9. The apparatus according to claim 1, wherein the information-updating unit comprises:
a check-out module configured to, in response to the check-out of the artifact, check-out the dependency information corresponding to the artifact; and
an update-check-in module configured to, in response to the check-in of the updated artifact, update the corresponding dependency information based on the updated artifact, and check-in the updated dependency information.

10. The apparatus according to claim 9, wherein the version-updating unit is configured to, in response to the check-in of the dependency information, update the version information of the dependency information according to the manner for updating the artifact version information.

11. The apparatus according to claim 1, further comprising a query unit, configured to query about dependency information of artifacts in response to the request from users, wherein the request from users comprises a direct query request and/or a nested query request.

12. A method comprising:
generating dependency information corresponding to an artifact;
in response to the generation of the dependency information, generating for the dependency information version information corresponding to that of the artifact;
in response to the update of the artifact, updating the dependency information corresponding to the artifact; and
in response to the update of the dependency information, assigning new version information to the updated dependency information, such that the new version information corresponds to the version information of the updated artifact.

13. The method according to claim 12, wherein generating dependency information corresponding to the artifact comprises generating dependency information by the way selected from one or more of the following:
static scanning;
program compilation; and
dynamic scanning.

14. The method according to claim 12, wherein in response to the update of the artifact, updating the dependency information corresponding to the artifact comprises detecting the update of the artifact by the way selected from one or more of the following items:
detecting the operation on interactive interfaces;
detecting the change of the version information of the artifact;
scanning the artifact regularly; and
receiving reports of changes.

15. The method according to claim 12, wherein updating the dependency information corresponding to the artifact comprises reanalyzing the updated artifact, and regenerating dependency information as the updated dependency information.

16. The method according to claim 12, wherein updating the dependency information corresponding to the artifact comprises obtaining a part of the artifact which is different before and after the update, and revising the dependency information based on the differential part, thereby obtaining the updated dependency information.

17. The method according to claim 12, wherein in response to the update of the artifact, updating the dependency information corresponding to the artifact comprises:
in response to the check-out of the artifact, checking out the dependency information corresponding to the artifact;
based on the updated artifact, updating the dependency information; and
in response to the check-in of the updated artifact, checking in the updated dependency information.

18. The method according to claim 12, wherein in response to the update of the artifact, updating the dependency information corresponding to the artifact comprises:
in response to the check-out of the artifact, checking out the dependency information corresponding to the artifact; and
in response to the check-in of the updated artifact, updating the corresponding dependency information based on the updated artifact, and checking in the updated dependency information.

19. The method according to claim 17, wherein assigning new version information to the updated dependency information comprises, in response to the check-in of the dependency information, updating the version information of the dependency information according to the manner for updating the artifact version information.

20. The method according to claim 12, further comprising a query step to query about dependency information of artifacts in response to the request from users, wherein the request from users comprises a direct query request and/or a nested query request.

21. A system comprising:
one or more processors, one or more computer-readable memories and one or more computer-readable, tangible storage devices;
program instructions, stored on at least one of the one or more storage devices for execution by at least one of the one or more processors via at least one of the one or more memories, to generate dependency information corresponding to an artifact;
program instructions, stored on at least one of the one or more storage devices for execution by at least one of the one or more processors via at least one of the one or more memories, to, in response to the generation of the dependency information, generate for the dependency information version information corresponding to that of the artifact;
program instructions, stored on at least one of the one or more storage devices for execution by at least one of the one or more processors via at least one of the one or more memories, to, in response to the update of the artifact, update the dependency information corresponding to the artifact; and
program instructions, stored on at least one of the one or more storage devices for execution by at least one of the one or more processors via at least one of the one or more memories, to, in response to the update of the dependency information, assign new version information to the updated dependency information, such that the new version information corresponds to the version information of the updated artifact.

22. The system according to claim 21, further comprising:
program instructions, stored on at least one of the one or more storage devices for execution by at least one of the one or more processors via at least one of the one or more memories, to, update the dependency information corresponding to the artifact by:
(i) in response to the check-out of the artifact, checking out the dependency information corresponding to the artifact;
(ii) based on the updated artifact, updating the dependency information; and
(iii) in response to the check-in of the updated artifact, checking in the updated dependency information.

23. The system according to claim 21, further comprising:
program instructions, stored on at least one of the one or more storage devices for execution by at least one of the one or more processors via at least one of the one or more memories, to, update the dependency information corresponding to the artifact by:
in response to the check-out of the artifact, checking out the dependency information corresponding to the artifact; and
in response to the check-in of the updated artifact, updating the corresponding dependency information based on the updated artifact, and checking in the updated dependency information.

24. A computer program product comprising:
one or more computer-readable storage devices;
program instructions, stored on at least one of the one or more storage devices, to generate dependency information corresponding to an artifact;
program instructions, stored on at least one of the one or more storage devices, to, in response to the generation of the dependency information, generate for the dependency information version information corresponding to that of the artifact;
program instructions, stored on at least one of the one or more storage devices, to, in response to the update of the artifact, update the dependency information corresponding to the artifact; and
program instructions, stored on at least one of the one or more storage devices, to, in response to the update of the dependency information, assign new version information to the updated dependency information, such that the new version information corresponds to the version information of the updated artifact.

25. The computer program product of claim 24, wherein program instructions to update the dependency information corresponding to the artifact comprises program instructions to obtain a part of the artifact which is different before and after the update, and program instructions to revise the dependency information based on the differential part, thereby obtaining the updated dependency information.
